(19) United States
(12) Patent Application Publication
(10) Pub. No.: US 2011/0244786 A1
(43) Pub. Date: Oct. 6, 2011

(54) REFLECTOR APPARATUS, RADIO BASE STATION AND RADIO COMMUNICATION METHOD

(75) Inventors: Hiromasa Fujii, Kanagawa (JP); Tomoyuki Ohya, Kanagawa (JP)

(73) Assignee: NTT DOCOMO, INC., Tokyo (JP)

(21) Appl. No.: 13/072,938

(22) Filed: Mar. 28, 2011

(30) Foreign Application Priority Data
Mar. 30, 2010 (JP) 2010-077636

(51) Int. Cl. H04B 7/14

(52) U.S. Cl. 455/7

(57) ABSTRACT

A reflector apparatus includes a reflector configured to reflect a directional beam transmitted from an array antenna of a radio base station to the reflector apparatus, a signal receiving unit configured to receive a training signal transmitted from the radio base station, a weight generating unit configured to generate an optimum weight of the directional beam transmitted from the radio base station based on the training signal reception result by the signal receiving unit and a control signal transmitting unit configured to transmit weight information indicating the optimum weight generated by the weight generating unit to the radio base station.

### CROSS REFERENCE TO RELATED APPLICATION

This application is based upon and claims the benefit of priority from the prior Japanese Patent Application No. 2010-077636, filed on Mar. 30, 2010; the entire contents of which are incorporated herein by reference.

### FIELD OF THE INVENTION

The present invention relates to a radio communication system that allows radio communication between a radio base station apparatus and a radio communication terminal via a reflector apparatus.

### BACKGROUND

In a radio communication system, a method for improving communication quality between a radio base station and a mobile station is proposed. In the method, a reflector that reflects a radio wave primary-radiated from an apparatus on the transmitting side (e.g., radio base station) and secondary-radiates the reflected radio wave toward a desired area. According to the method, even when a line-of-sight propagation path between an antenna of a radio base station and a mobile station is blocked by an obstacle such as a person or vehicle, the radio base station radiates a non-directional radio wave that covers the entire cell and also radiates a directional beam toward a reflector so that the radio wave is radiated from behind the obstacle. Thus, using the reflector that reflects the radio wave radiated from the radio base station to a desired area can eliminate dead regions and expand coverage.

However, the aforementioned radio communication system radiates a non-directional radio wave that covers the entire cell regardless of whether or not the radio wave radiated from the radio base station is blocked by an obstacle and communication quality of the mobile station deteriorates. Consequently, power entering the reflector is small and power secondarily radiated from the reflector is also small, therefore it is impossible to obtain the advantage of utilizing the reflector. Furthermore, by using non-directional antennas, transmission is performed without distinguishing between communication the reflector and direct communication without the reflector, and therefore a signal propagates even to an unnecessary area as an interference signal, resulting in a problem that it is not possible to sufficiently obtain the effect of improving throughput of the entire radio communication system.

### SUMMARY OF THE INVENTION

The present invention has been implemented in view of such problems and it is an object of the present invention to provide a reflector apparatus, a radio base station and a radio communication method capable of sufficiently achieving the effect of utilizing a reflector arranged in a cell of the radio base station, determining an optimum communication mode including a communication mode using the reflector according to a situation of the radio communication terminal, and thereby improving throughput of the entire radio communication system.

The reflector apparatus of the present invention includes a reflector apparatus arranged in a cell formed by a radio base station, including a reflector configured to reflect a directional beam transmitted from an array antenna of the radio base station to the reflector apparatus, a receiving unit configured to receive a training signal transmitted from the radio base station, a weight generating unit configured to generate an optimum weight of the directional beam transmitted from the radio base station, based on a reception result of the training signal by the receiving unit, and a transmitting unit configured to transmit weight information indicating the optimum weight generated by the weight generating unit to the radio base station.

The radio base station of the present invention is a radio base station forming a cell in which at least one reflector apparatus is arranged, including an acquiring unit configured to acquire, from each radio communication terminal, receiving power information of a first control signal transmitted from the radio base station and received by each radio communication terminal and receiving power information of a second control signal transmitted from the radio base station by using a directional beam directed to the reflector apparatus and received by each radio communication terminal, a communication mode determining unit configured to determine a communication mode for each radio communication terminal from among a direct mode for communicating without the reflector apparatus, a reflector relay mode for communicating via the reflector apparatus by using a directional beam formed between the radio base station and the reflector apparatus, and a combined mode for communicating by combining the direct mode and the reflector relay mode, based on the receiving power information acquired from each radio communication terminal, and a communication unit configured to communicate with each radio communication terminal by using the communication mode determined for each radio communication terminal.

The radio communication method of the present invention can include a radio communication method for a radio communication system including a radio base station and at least one reflector apparatus arranged in a cell formed by the radio base station, including acquiring, in the radio base station, from each radio communication terminal, receiving power information of a first control signal transmitted from the radio base station and received by each radio communication terminal and receiving power information of a second control signal transmitted from the radio base station by using a directional beam directed to the reflector apparatus and received by each radio communication terminal, determining, in the radio base station, a communication mode for each radio communication terminal from among a direct mode for communicating without the reflector apparatus, a reflector relay mode for communicating via the reflector apparatus by using a directional beam formed between the radio base station and the reflector apparatus, and a combined mode for communicating by combining the direct mode and the reflector relay mode, based on the receiving power information acquired from the each radio communication terminal, and communicating, in the radio base station, with each radio communication terminal by using the communication mode determined for each radio communication terminal.

### BRIEF DESCRIPTION OF THE DRAWINGS

FIG. 1 is a schematic diagram of a radio communication system according to a first embodiment of the present invention;

FIG. 2A is a diagram illustrating a communication mode according to the first embodiment of the present invention;

FIG. 2B is a diagram illustrating a communication mode according to the first embodiment of the present invention;

FIG. 2C is a diagram illustrating a communication mode according to the first embodiment of the present invention;

FIG. 2D is a diagram illustrating a communication mode according to the first embodiment of the present invention;

FIG. 3 is a function block diagram of a radio base station according to the first embodiment of the present invention;

FIG. 4 is a diagram for illustrating receiving power information acquired by the radio base station according to the first embodiment of the present invention;

FIG. 5A is a diagram for illustrating radio resources according to the first embodiment of the present invention;

FIG. 5B is a diagram for illustrating radio resources according to the first embodiment of the present invention;

FIG. 6 is a conceptual diagram of the radio communication system according to the first embodiment of the present invention;

FIG. 7 is a function block diagram of the reflector apparatus according to the first embodiment of the present invention;

FIG. 8 is a sequence diagram illustrating a radio communication method according to the first embodiment of the present invention;

FIG. 9 is a flowchart illustrating a communication mode determining operation by the radio base station according to the first embodiment of the present invention;

FIG. 10 is a diagram illustrating allocation of radio resources to radio communication terminals by the radio base station according to the first embodiment of the present invention;

FIG. 11 is a schematic diagram of a radio communication system according to a second embodiment of the present invention;

FIG. 12 is a schematic diagram of a radio communication system according to a third embodiment of the present invention;

FIG. 13 is a schematic diagram of a radio communication system according to a fourth embodiment of the present invention;

FIG. 14 is a schematic diagram of a radio communication system according to a fifth embodiment of the present invention; and

FIG. 15 is a function block diagram of a reflector apparatus according to another embodiment of the present invention.

### DETAILED DESCRIPTION OF THE INVENTION

Hereinafter, embodiments of the present invention will be described with reference to the accompanying drawings. In descriptions of the following drawings, identical or similar parts will be assigned identical or similar reference numerals.

### First Embodiment

(Overall Schematic Configuration of Radio Communication System)

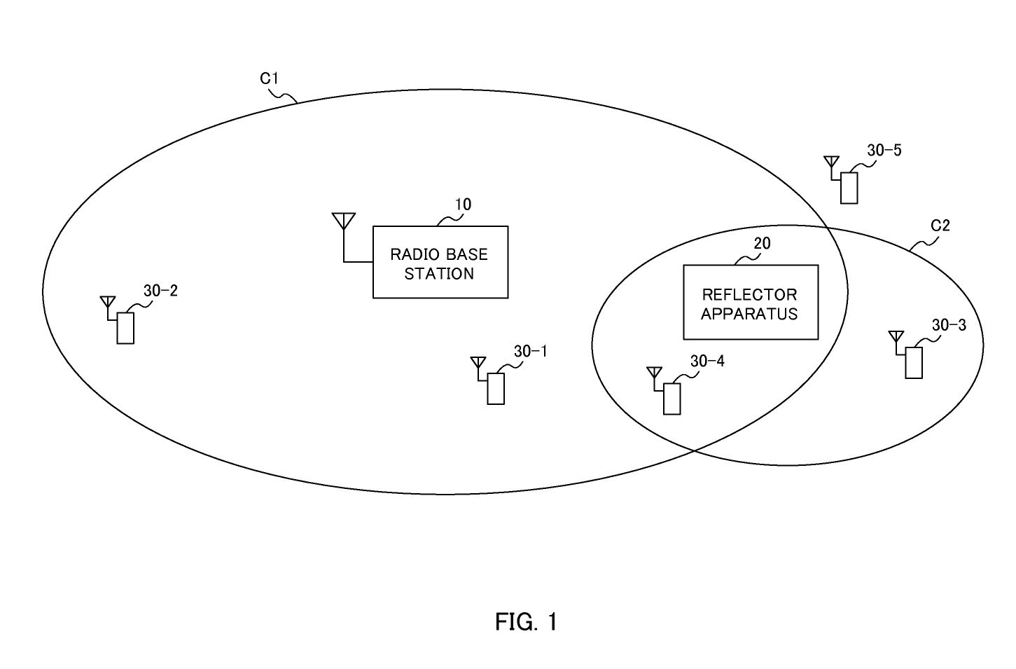

FIG. 1 is a schematic diagram of a radio communication system according to a first embodiment. As shown in FIG. 1, the radio communication system includes a radio base station 10, a reflector apparatus 20 arranged in a cell C1 of the radio base station 10 and radio communication terminals 30-1 to 30-5. Hereinafter, the radio communication terminals 30-1 to 30-5 will be referred to as “radio communication terminal 30” when no distinction is made therebetween. The numbers or modes of the radio base station 10, reflector apparatus 20 and radio communication terminal 30 included in the radio communication system are not limited to those shown in FIG. 1.

The radio base station 10 determines a communication mode for each radio communication terminal 30 from among a direct mode, a reflector relay mode and a combined mode that combines the direct mode and reflector relay mode, based on receiving power information acquired from each radio communication terminal 30. For example, in the radio communication system shown in FIG. 1, the radio base station 10 determines the communication mode of the radio communication terminal 30-2 to be a direct mode, the communication mode of the radio communication terminal 30-3 to be a reflector relay mode, the communication modes of the radio communication terminals 30-1 and 30-4 to be a capacity increasing mode included in a combined mode and the communication mode of the radio communication terminal 30-5 to be an area expanding mode included in the combined mode.

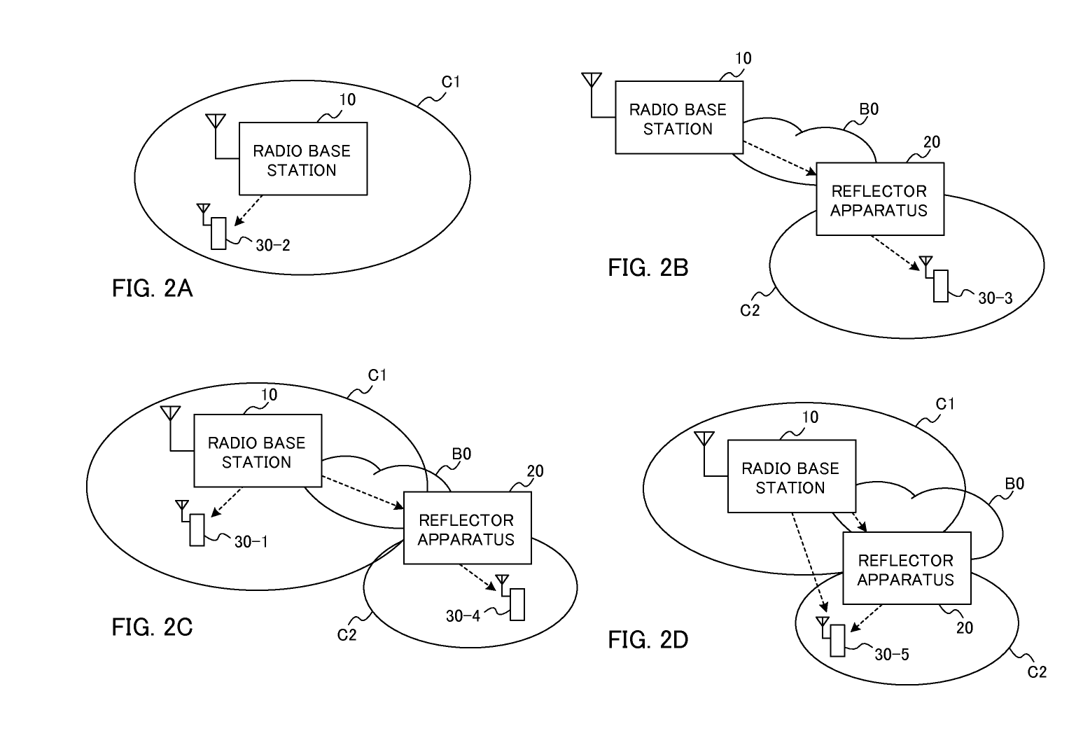

Here, the direct mode is a communication mode in which the radio base station 10 directly communicates with the radio communication terminal 30 without the reflector apparatus 20. In downlink communication, radio base station 10 transmits a downlink signal to the radio communication terminal 30-2 by using a non-directional beam (not shown) directed to the entire cell C1 as shown in FIG. 2A. On the other hand, in uplink communication (not shown), the radio base station 10 receives an uplink signal transmitted from the radio communication terminal 30-2. The radio base station 10 may also communicate with the radio communication terminal 30-2 by using a directional beam instead of the non-directional beam.

The reflector relay mode is a communication mode in which the radio base station 10 forms a directional beam directed to the reflector apparatus 20 and the radio base station 10 communicates with the radio communication terminal 30 via the reflector apparatus 20. To be more specific, in downlink communication, the radio base station 10 transmits a downlink signal to the radio communication terminal 30-3 by using a directional beam B0 directed to the reflector apparatus 20 as shown in FIG. 2B. The reflector apparatus 20 reflects the downlink signal entering from the radio base station 10 to a predetermined area (hereinafter referred to as “reflection area”). The downlink signal reflected by a reflector set in the reflector apparatus 20 is transmitted to the radio communication terminal 30-3 located in the reflection area. On the other hand, in uplink communication (not shown), the reflector apparatus 20 reflects an uplink signal entering from the radio communication terminal 30-3 located in the reflection area to the radio base station 10. The radio base station 10 receives the uplink signal reflected by the reflector apparatus 20.

The combined mode includes a capacity increasing mode that combines the direct mode and reflector relay mode for a plurality of radio communication terminals 30 and an area expanding mode that combines the direct mode and reflector relay mode for one radio communication terminal 30.

The capacity increasing mode is a communication mode in which the radio base station 10 communicates with one radio communication terminal 30 by the direct mode and further communicates with another radio communication terminal 30 by the reflector relay mode, by using same radio resources. In downlink communication, as shown in FIG. 2C, the radio base station 10 transmits a downlink signal to the radio communication terminal 30-1 by using a non-directional beam (not shown) directed to the entire cell C1 and further transmits a downlink signal to the radio communication terminal 30-4 by using a directional beam B0 directed to the reflector apparatus 20. The reflector apparatus 20 receives the directional beam B0 from the radio base station 10 and reflects the downlink signal to a reflection area in which the radio communication terminal 30-4 is located. On the other hand, in uplink communication (not shown), the reflector apparatus 20 reflects an uplink signal entering from the radio communication terminal 30-4 located in the reflection area to the radio base station 10. The radio base station 10 receives the uplink signal arriving via the reflector apparatus 20 and further receives an uplink signal directly arriving from the radio communication terminal 30-1.

The area expanding mode is a communication mode in which the radio base station 10 communicates with the radio communication terminal 30 by the direct mode and further communicates with the same radio communication terminal 30 by the reflector relay mode, by using the same radio resources. To be more specific, in downlink communication, as shown in FIG. 2D, the radio base station 10 transmits a downlink signal to the radio communication terminal 30-5 by using a non-directional beam (not shown) directed to the entire cell C1 and further transmits the same downlink signal by using the directional beam B0 directed to the reflector apparatus 20. The reflector apparatus 20 reflects a downlink signal carried on the directional beam B0 entering from the radio base station 10 to a reflection area in which the same radio communication terminal 30-5 is located. On the other hand, in uplink communication (not shown), the reflector apparatus 20 reflects an uplink signal entering from the radio communication terminal 30-5 located in the reflection area to the radio base station 10. The radio base station 10 receives the uplink signal reflected from the reflector apparatus 20 and further receives the same uplink signal transmitted and directly arriving from the radio communication terminal 30-5.

The radio base station 10 communicates with each radio communication terminal 30 in the above communication modes determined for each radio communication terminal.

(Functional Configuration of Radio Communication System)

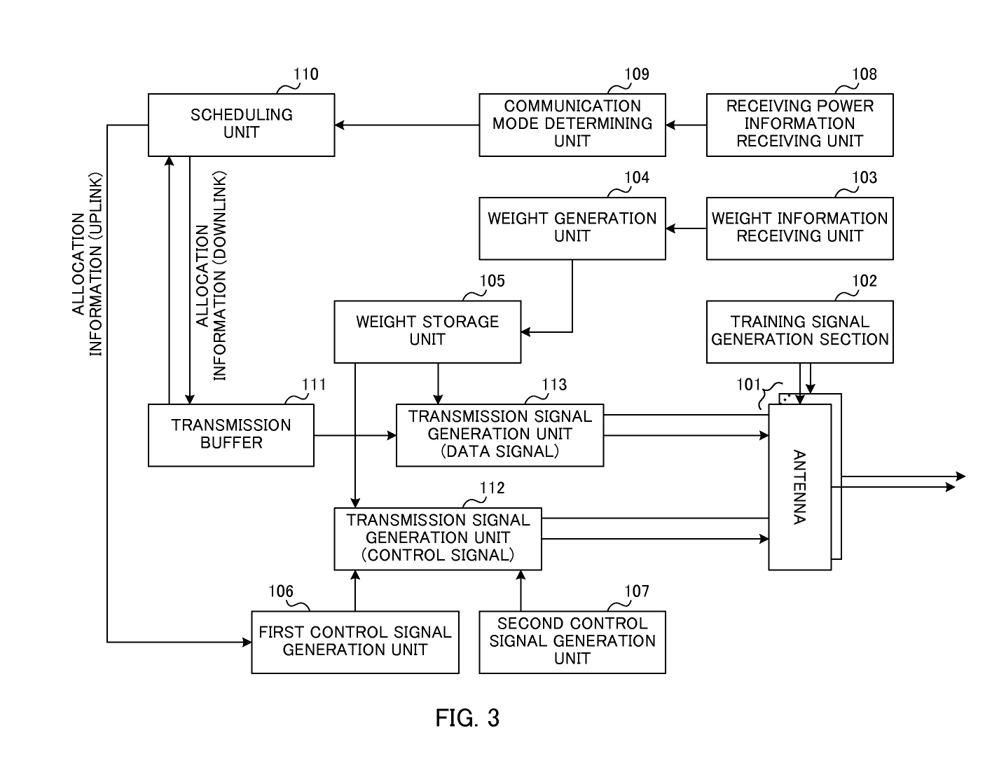

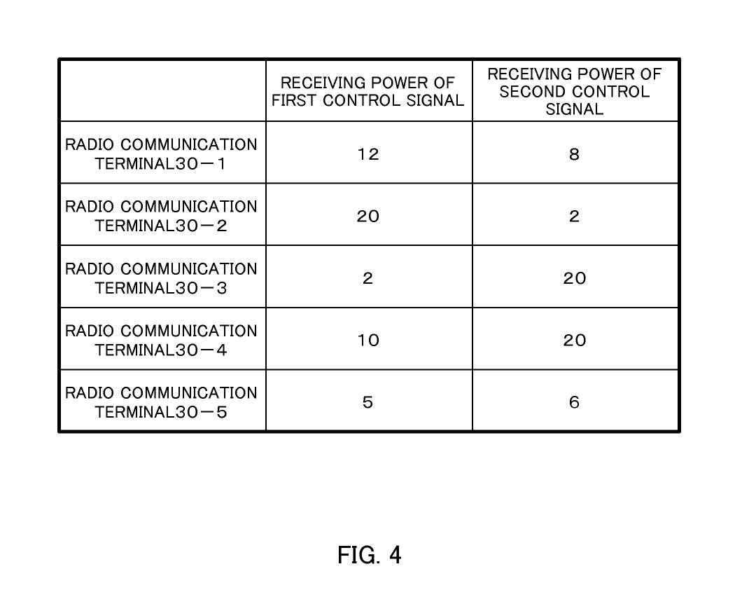

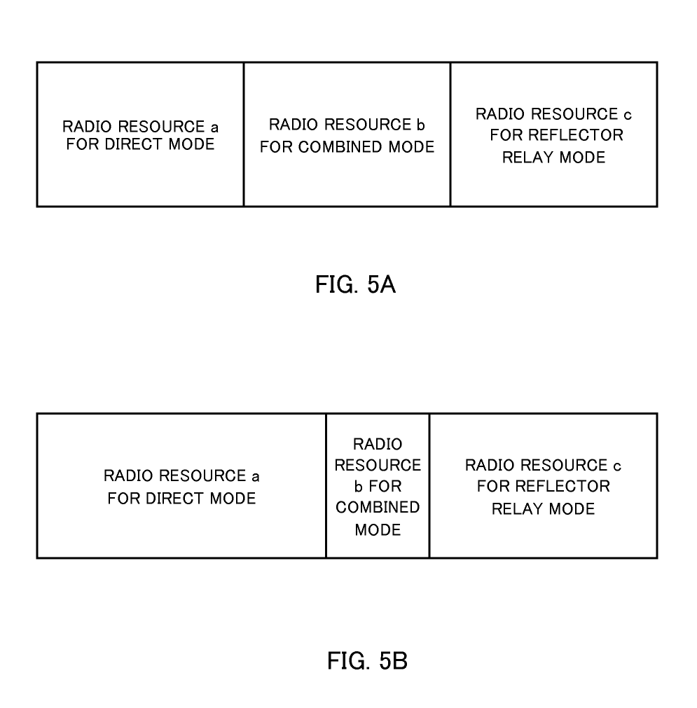

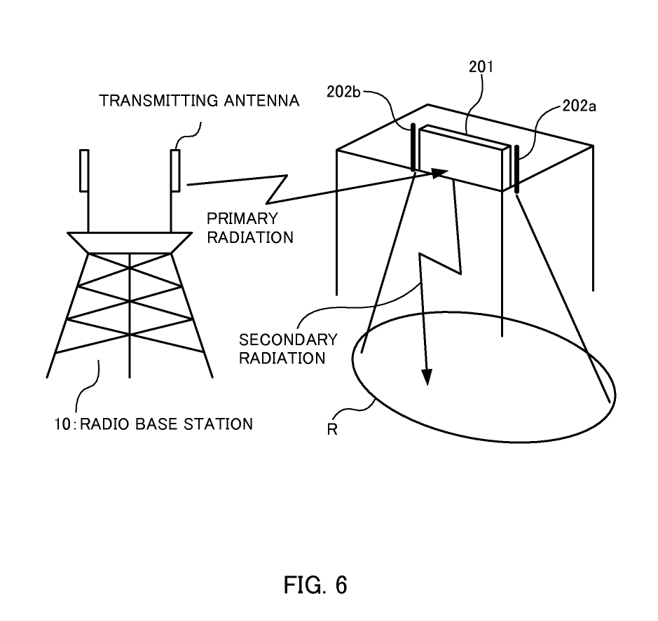

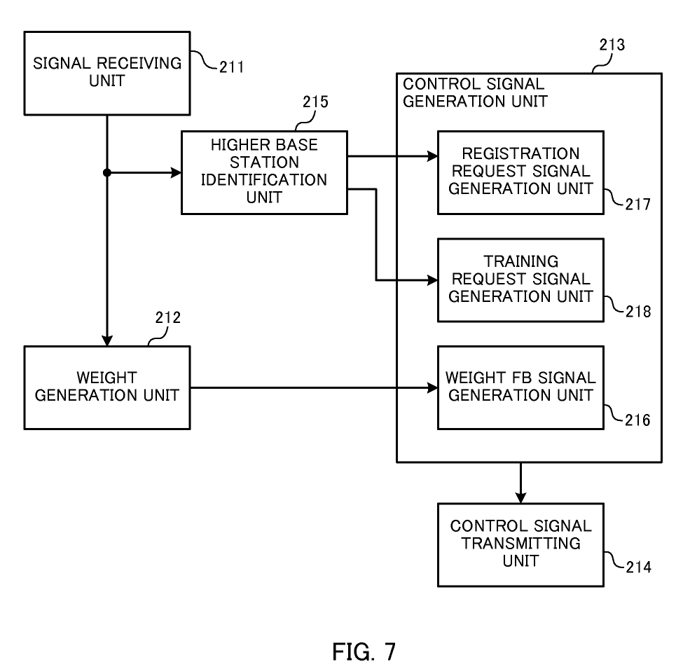

Next, a functional configuration of the radio base station 10 and reflector apparatus 20 constituting the radio communication system according to the first embodiment will be described. FIG. 3 is a functional block diagram of the radio base station 10, FIG. 4 and FIG. 5 are diagrams for illustrating a functional configuration of the radio base station 10, FIG. 6 is a schematic outside view of the radio base station 10 and reflector apparatus 20 and FIG. 7 is a function block diagram of the reflector apparatus 20.

(1) Functional Configuration of Radio Base Station 10

As shown in FIG. 3, the radio base station 10 is provided with an array antenna 101 comprised of a plurality of antennas, a training signal generation unit 102, a weight information receiving unit 103, a weight generating unit 104, a weight storage unit 105, a first control signal generation unit 106, a second control signal generation unit 107, a receiving power information receiving unit 108, a communication mode determining unit 109, a scheduling unit 110, a transmission buffer 111 and transmission signal generation units 112 and 113.

The training signal generation unit 102 generates a training signal transmitted from the array antenna 101 to the reflector apparatus 20. The “training signal” is a dummy signal to determine an optimum weight of the directional beam B0 directed to the reflector apparatus 20.

The weight information receiving unit 103 receives weight information determined based on the reception result of the training signal in the reflector apparatus 20 from the reflector apparatus 20. The weight generating unit 104 generates an optimum weight of the directional beam B0 directed to the reflector apparatus 20 based on the weight information received by the weight information receiving unit 103. The weight storage unit 105 stores the weight generated in association with the reflector apparatus 20.

The first control signal generation unit 106 generates a first control signal transmitted from the array antenna 101 by using a non-directional beam directed to the entire cell C1. On the other hand, the second control signal generation unit 107 generates a second control signal transmitted from the array antenna 101 by using the directional beam B0 directed to the reflector apparatus 20. The second control signal includes a reflector ID which is identification information of the reflector apparatus 20. Furthermore, as will be described later, the second control signal is reflected by the reflector apparatus 20 to the reflection area and transmitted to the radio communication terminal 30 located in the reflection area.

The receiving power information receiving unit 108 receives receiving power information of the first control signal and second control signal from the radio communication terminal 30. The “receiving power information” indicates receiving power of a signal at the radio communication terminal 30, which is, for example, SINR. For example, as shown in FIG. 4, the receiving power information receiving unit 108 receives receiving power (unit is dB) of the first control signal and second control signal from the radio communication terminals 30-1 to 30-5 in FIG. 1. The receiving power information receiving unit 108 may also receive receiving power information of a combined signal of the first control signal and second control signal from the radio communication terminal 30 in addition to the receiving power information of the first control signal and the receiving power information of the second control signal.

The communication mode determining unit 109 determines the communication mode used for communication with the radio communication terminal 30 to be one of the direct mode, reflector relay mode, capacity increasing mode and area expanding mode based on the receiving power information of the first control signal and second control signal received by the receiving power information receiving unit 108.

The scheduling unit 110 assigns radio resources to the radio communication terminal 30 whose communication mode is determined by the communication mode determining unit 109. Here, radio resources may be fixedly allocated or dynamically allocated for each communication mode. Here, radio resources may be allocated on a time-division basis or may also be allocated on a frequency-division basis for each communication mode.

For example, in FIG. 5A, radio resource a for direct mode, radio resource b for combined mode including capacity increasing mode and area expanding mode and radio resource c for reflector relay mode are fixedly allocated at ratios corresponding to an amount of traffic in each communication mode. In such a case, the scheduling unit 110 allocates the radio resource a for direct mode to the radio communication terminal 30 for which the direct mode is determined by using a scheduling algorithm such as round robin, Proportion fair. Similarly, the scheduling unit 110 allocates the radio resource b for combined mode or radio resource c for reflector relay mode to the radio communication terminal 30 for which the combined mode or reflector relay mode is determined.

Furthermore, in FIG. 5B, the radio resource a for direct mode, radio resource b for combined mode including capacity increasing mode and area expanding mode and radio resource c for reflector relay mode are dynamically allocated. In such a case, the scheduling unit 110 selects n radio communication terminals 30 having a high Proportional fair index (instantaneous SINR/average SINR) from among all the radio communication terminals 30. The scheduling unit 110 assigns the radio resources a, b and c at a ratio corresponding to the amount of traffic for each communication mode of the selected n radio communication terminals 30. When, for example, a ratio in the amount of traffic among the communication modes of the selected n radio communication terminals 30 is 6:1:3 (direct mode:combined mode:reflector relay mode), the radio resources a, b and c are also allocated at a ratio of 6:1:3.

The transmission signal generation unit 112 converts the first control signal generated by the first control signal generation unit 106 to a transmission signal in a predetermined format. Furthermore, the transmission signal generation unit 112 converts the second control signal generated by the second control signal generation unit 107 to a transmission signal in a predetermined format, based on a weight stored in the weight storage unit 105. The transmission signal generation unit 113 converts the downlink data signal stored in transmission buffer 111 to a transmission signal in a predetermined format.

(2) Functional Configuration of Reflector Apparatus 20

As shown in FIG. 6, the reflector apparatus 20 is provided with a reflector 201 having a predetermined form (e.g., rectangular form), two antennas 202a and 202b arranged on the left and right of the reflector 201 and a control unit 203 (not shown). The antennas 202a and 202b provided for the reflector apparatus 20 may also be arranged above and below the reflector 201 or four antennas may be arranged above and below and to the right and left of the reflector 201. Reference character R denotes a reflection area covered by the reflector apparatus 20. Furthermore, the number of antennas 202 arranged in the reflector 201 is not limited to two but may be one. Furthermore, four antennas 202 may also be arranged above and below and to the right and left of the reflector 201. FIG. 6 illustrates the reflector 201 secondary-radiating a primary-radiated signal from the radio base station 10, but the reflector 201 may also secondary-radiate a signal primary-radiated from the radio communication terminal 30 (not shown) within the reflection area R.

FIG. 7 is a function block of the control unit 203 of the reflector apparatus 20. The control unit 203 of the reflector apparatus 20 is provided with a signal receiving unit 211 (receiving unit), a weight generating unit 212, a control signal generation unit 213, a control signal transmitting unit 214 (transmitting unit) and a higher base station identification unit 215.

The signal receiving unit 211 acquires a downlink signal received through the antennas 202a and 202b, and an uplink signal (data signal, control signal and training signal transmitted from the radio base station 10 and a data signal and control signal transmitted from the radio communication terminal 30).

The weight generating unit 212 generates an optimum weight of the directional beam B0 transmitted from the array antenna 101 of the radio base station 10 to the reflector apparatus 20 based on the reception result of the training signal received by the signal receiving unit 211. When one antenna 202 is set up in the reflector 201, the weight generating unit 212 may also generate an optimum weight by using maximum ratio combining. Furthermore, when a plurality of antennas 202 are set up in the reflector 201, the weight generating unit 212 may calculate an average value of optimum weights generated by using maximum ratio combining for each antenna 202 and determine the calculated average value to be an optimum weight.

The control signal generation unit 213 generates a control signal including the weight information indicating the optimum weight generated by the weight generating unit 212. In the configuration example shown in FIG. 7, a weight FB signal generation section 216 generates weight information indicating the optimum weight, but the radio base station 10 may use channel information and antenna setup condition (e.g., the number of antennas 202, setup location of the antenna 202 (that is, relative position of the antenna 202 with respect to reflector 201)) obtained from the downlink signal of the radio base station 10 as feedback information to generate an optimum weight of the directional beam B0. The control signal transmitting unit 214 transmits a control signal including the weight information generated by the weight generating unit 212 to the radio base station 10.

The control signal generation unit 213 is provided with a registration request signal generation unit 217 and a training request signal generation unit 218. The higher base station identification unit 215 inputs signals to identify the radio base station 10 controlling the reflector apparatus 20, to the registration request signal generation unit 217 and the training request signal generation unit 218.

The registration request signal generation unit 217 generates a registration request signal for requesting the radio base station 10 to register the reflector apparatus 20. The training request signal generation unit 218 generates a training request signal for requesting the radio base station 10 to transmit a training signal. When the reflector apparatus 20 is newly set up, the registration request signal generation unit 217 generates a registration request signal and transmits the registration request signal to the radio base station 10. Furthermore, when the reflector apparatus 20 is newly set up or appropriately, the training request signal generation unit 218 generates a training request signal and transmits the training request signal to the radio base station 10.

The radio communication terminal 30 determines the communication mode depending on whether or not the reflector ID is included in the received downlink signal. The communication mode can be determined to be a reflector relay mode when the reflector ID is included and a direct communication mode when the reflector ID is not included. The radio base station 10 transmits the reflector ID carried on the second control signal. The radio communication terminal 30 measures receiving power of the received signal including the reflector ID (second control signal via the reflector) and receiving power of the received signal not including the reflector ID (first control signal without the reflector), and reports the respective receiving power information to the radio base station 10. Furthermore, the radio communication terminal 30 can also compare the receiving power of the first control signal with the receiving power of the second control signal to determine the communication mode. When the radio communication terminal 30 determines the communication mode, the determined communication mode is reported to the radio base station 10.

(Operation of Radio Communication System According to First Embodiment)

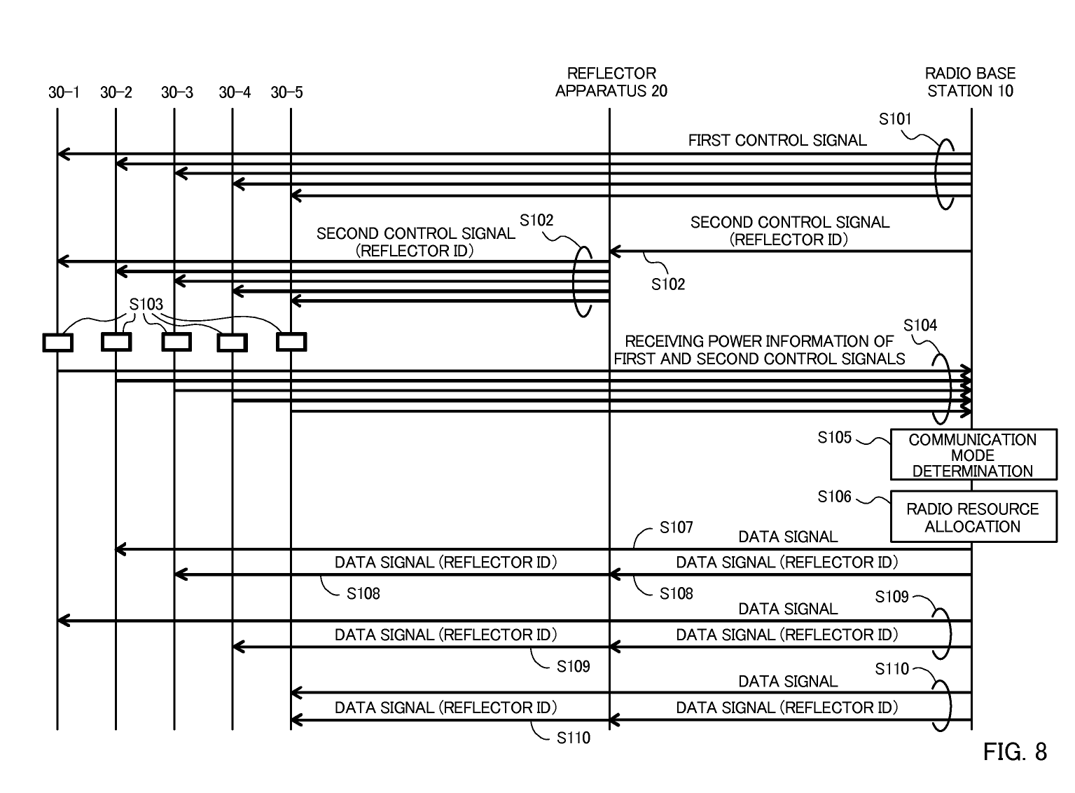

Next, operation of the radio communication system configured as shown above will be described with reference to FIG. 8 to FIG. 10. FIG. 8 is a sequence diagram showing a radio communication method according to the first embodiment. Hereinafter, as shown in FIG. 1, suppose the reflector apparatus 20 is arranged in the cell C1 of the radio base station 10, the radio communication terminals 30-1 and 30-2 are located in the cell C1 of the radio base station 10, the radio communication terminals 30-3 and 30-4 are located in the reflection area C2 of the reflector apparatus 20, the radio communication terminal 30-5 is located outside the cell C1 and reflection area C2 and the radio communication terminals 30-1 to 30-5 are communicating with each other over a downlink.

As shown in FIG. 8, in step S101, the radio base station 10 broadcasts a first control signal directed to the entire cell C1 by using a non-directional beam. Since the first control signal entering the reflector apparatus 20 from the radio base station 10 does not include the reflector ID of the reflector apparatus 20, the reflector apparatus 20 does not reflect the first control signal to the reflection area C2. Since the radio communication terminals 30-1, 30-2 and 30-4 are located in the cell C1, these terminals directly receive the first control signal broadcast from the radio base station 10. On the other hand, since the radio communication terminals 30-3 and 30-5 are located outside the cell C1, these terminals cannot always receive the first control signal broadcast from the radio base station 10 and even if the terminals can receive the first control signal, its receiving power drastically reduces compared to that within the cell C1. Upon receiving a control signal not including the reflector ID, the radio communication terminal 30-1 to 30-5 can determine that the control signal is the first control signal. Furthermore, the first control signal may also include identification information indicating that the signal is directly transmitted from the radio base station 10 without the reflector apparatus 20 and upon receiving the control signal including the identification information, the radio communication terminals 30-1 to 30-5 may determine that the control signal is the first control signal.

In step S102, the radio base station 10 broadcasts a second control signal including the reflector ID of the reflector apparatus 20 by using a directional beam B0 directed to the reflector apparatus 20. Since the second control signal entering the reflector apparatus 20 from the radio base station 10 includes the reflector ID of the reflector apparatus 20, the reflector apparatus 20 reflects the second control signal toward the reflection area C2. Since the radio communication terminals 30-3 and 30-4 are located within the reflection area C2 of the reflector apparatus 20, these terminals receive the second control signal broadcast from the reflector apparatus 20. On the other hand, since the radio communication terminals 30-1, 30-2 and 30-5 are located outside the reflection area C2 of the reflector apparatus 20, these terminals cannot always receive the second control signal broadcast from the reflector apparatus 20 and even if the terminals can receive the second control signal, its receiving power drastically reduces compared to that in the reflection area C2. Upon receiving a control signal including the reflector ID, the radio communication terminals 30-1 to 30-5 can determine that the control signal is the second control signal.

In step S103, the radio communication terminals 30-1 to 30-5 measure the receiving power of the first control signal and the receiving power of the second control signal. As described above, the radio communication terminals 30-3 and 30-5 cannot always receive the first control signal and even if the terminals can receive the first control signal, the receiving power of the first control signal drastically reduces compared to that of the radio communication terminals 30-1, 30-2 and 30-4 within the cell C1. Likewise, the radio communication terminals 30-1, 30-2 and 30-5 cannot always receive the second control signal and even if the terminals can receive the second control signal, the receiving power of the second control signal drastically reduces compared to that of the radio communication terminals 30-3 and 30-4 within the reflection area C2.

In step S104, the radio communication terminals 30-1 to 30-5 report receiving power information of the first control signal and second control signal measured in step S103 to the radio base station 10.

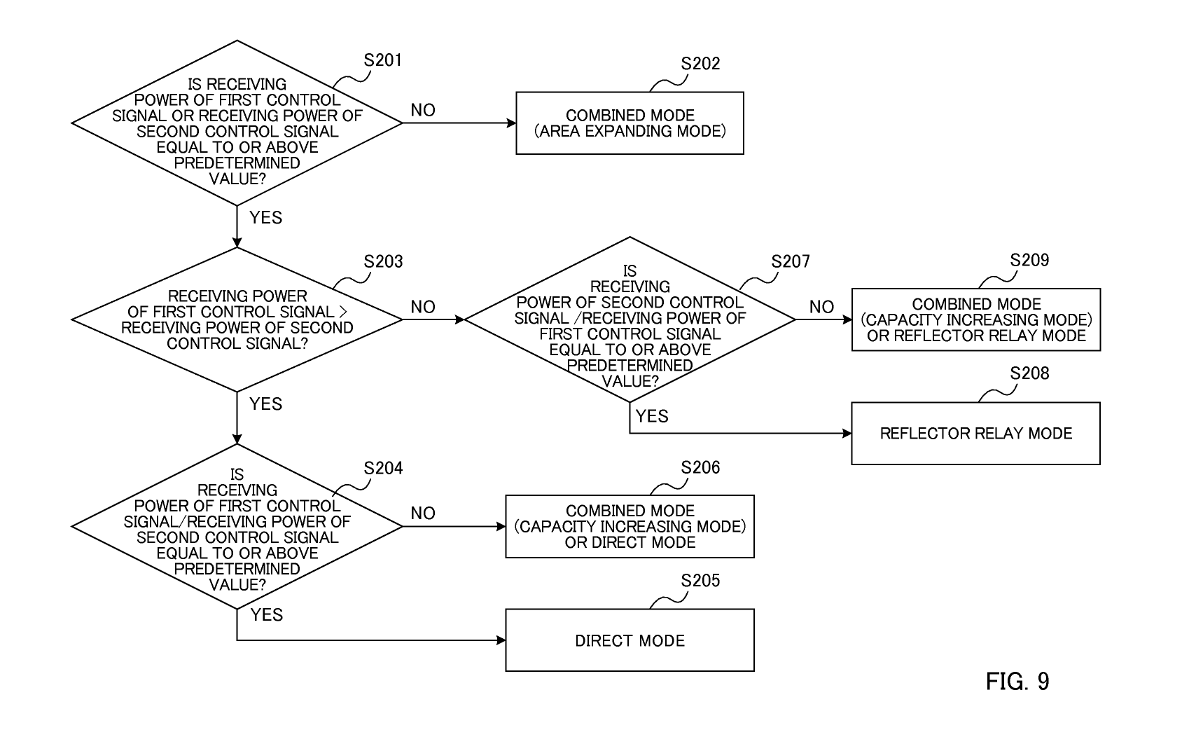

In step S105, the radio base station 10 determines communication modes used for communication with the radio communication terminals 30-1 to 30-5 respectively based on the receiving power information of the first control signal and second control signal reported from the radio communication terminals 30-1 to 30-5. Here, the operation of determining a communication mode used by the radio base station 10 to communicate with each radio communication terminal 30 will be described in detail with reference to FIG. 9. FIG. 9 is a flowchart showing a communication mode determining operation. Hereinafter, suppose the radio base station 10 receives the receiving power information shown in FIG. 4 from the radio communication terminals 30-1 to 30-5.

As shown in FIG. 9, in step 201, the radio base station 10 determines, based on the receiving power information reported from the radio communication terminal 30, whether the receiving power of the first control signal or the receiving power of the second control signal at the radio communication terminal 30 is equal to or above a predetermined value.

When the receiving power of the first control signal or the receiving power of the second control signal at the radio communication terminal 30 is less than the predetermined value (step S201: No), in step S202, the radio base station 10 determines the communication mode of the radio communication terminal 30 to be an “area expanding mode” included in a combined mode. For example, in the radio communication terminal 30-5 shown in FIG. 1, both the receiving power (5 dB in FIG. 4) of the first control signal from the radio base station 10 and the receiving power (6 dB in FIG. 4) of the second control signal from the reflector apparatus 20 are below a predetermined value (e.g., 10 dB). Thus, in this step, the radio base station 10 determines the communication mode of the radio communication terminal 30-5 to be an “area expanding mode”.

When the receiving power of the first control signal or the receiving power of the second control signal at the radio communication terminal 30 is equal to or above the predetermined power (step S201: Yes), in step S203, the radio base station 10 determines whether or not the receiving power of the first control signal is greater than the receiving power of the second control signal.

When the receiving power of the first control signal at the radio communication terminal 30 is greater than the receiving power of the second control signal (step S203: Yes), in step 204, the radio base station 10 determines whether or not the ratio of the receiving power of the first control signal to the second control signal (that is, receiving power of the first control signal/receiving power of the second control signal) is equal to or above a predetermined value.

When the ratio of the receiving power of the first control signal to the second control signal is equal to or above the predetermined value (step S204: Yes), in step S205, the radio base station 10 determines the communication mode of the radio communication terminal 30 to be a “direct mode.” For example, in the radio communication terminal 30-2 shown in FIG. 1, the receiving power of the first control signal (20 dB in FIG. 4) is greater than the receiving power of the second control signal (2 dB in FIG. 4) and the ratio of the receiving power of the first control signal to the second control signal is equal to or above a predetermined value (e.g., 10). For this reason, in the present step, the radio base station 10 determines the communication mode of the radio communication terminal 30-2 to be a “direct mode.”

When the ratio of the receiving power of the first control signal to the second control signal is less than the predetermined value (step S204: No), in step S206, the radio base station 10 determines the communication mode of the radio communication terminal 30 to be a “capacity increasing mode” included in the combined mode. However, when there is no other radio communication terminal 30 that pairs with the radio communication terminal 30 in the capacity increasing mode, that is, another radio communication terminal 30 that moves to step S209 which will be described later, the radio base station 10 determines the communication mode of the radio communication terminal 30 to be a “direct mode.”

For example, in the radio communication terminal 30-1 shown in FIG. 1, the receiving power of the first control signal (12 dB in FIG. 4) is greater than the receiving power of the second control signal (8 dB in FIG. 4) and the ratio of the receiving power of the first control signal to the second control signal is less than a predetermined value (e.g., 10). Furthermore, in the case shown in FIG. 1, there exists the radio communication terminal 30-4 that pairs with the radio communication terminal 30-1 in the “capacity increasing mode.” For this reason, the radio base station 10 determines the communication mode used for communication with the radio communication terminal 30-1 in the present step to be a “capacity increasing mode.”

When the receiving power of the second control signal at the radio communication terminal 30 is equal to or above the receiving power of the first control signal (step S203: No), the radio base station 10 determines in step 207 whether or not the ratio of the receiving power of the second control signal to the first control signal (that is, receiving power of the second control signal/receiving power of the first control signal) is equal to or above a predetermined value.

When the ratio of the receiving power of the second control signal to the first control signal is equal to or above the predetermined value (step S207: Yes), the radio base station 10 determines the communication mode of the radio communication terminal 30 to be the “reflector relay mode” in step S208. For example, in the radio communication terminal 30-3 shown in FIG. 1, the receiving power of the second control signal (20 dB in FIG. 4) is equal to or above the receiving power of the first control signal (2 dB in FIG. 4) and the ratio of the receiving power of the second control signal to the first control signal is equal to or above the predetermined value (e.g., 10). For this reason, the radio base station 10 determines the communication mode of the radio communication terminal 30-3 to be a “reflector relay mode” in the present step.

When the ratio of the receiving power of the second control signal to the first control signal is less than the predetermined value (step S207: No), the radio base station 10 determines the communication mode of the radio communication terminal 30 to be a “capacity increasing mode” in step S209. However, in the capacity increasing mode, when there is no other radio communication terminal 30 that pairs with the radio communication terminal 30, that is, another radio communication terminal 30 that moves to aforementioned step S206, the radio base station 10 determines the communication mode of the radio communication terminal 30 to be a “reflector relay mode.”

For example, in the radio communication terminal 30-4 shown in FIG. 1, the receiving power of the second control signal (20 dB in FIG. 4) is equal to or above the receiving power of the first control signal (10 dB in FIG. 4) and the ratio of the receiving power of the second control signal to the first control signal is also less than the predetermined value (e.g., 10). Furthermore, in the case shown in FIG. 1, there exists the radio communication terminal 30-1 that pairs with the radio communication terminal 30-4 in the “capacity increasing mode.” For this reason, the radio base station 10 determines the communication mode used for communication with the radio communication terminal 30-4 to be a “capacity increasing mode” in the present step.

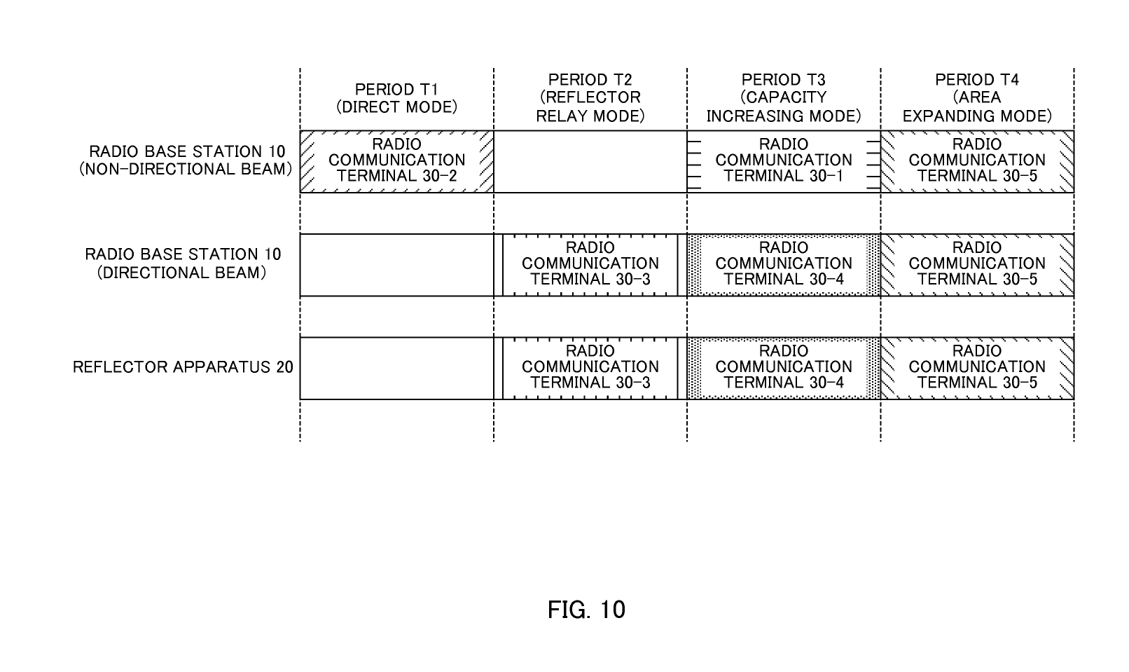

As described above, in step S105 in FIG. 8, the radio base station 10 determines the communication mode used for communication with the radio communication terminals 30-1 to 30-5. In step S106, the radio base station 10 assigns radio resources to the radio communication terminals 30-1 to 30-5 for which the communication mode is determined in step S105. FIG. 10 is a diagram illustrating an example of radio resource allocation to the radio communication terminal 30 for which the communication mode is determined. FIG. 10 shows an example where radio resources are assigned to a radio communication terminal in each communication mode on a time-division basis, but radio resources may also be allocated on a frequency-division basis.

As shown in FIG. 10, the radio base station 10 assigns a period T1 to the radio communication terminal 30-2 for which the “direct mode” is determined. Furthermore, the radio base station 10 assigns a period T2 to the radio communication terminal 30-3 for which the “reflector relay mode” is determined. Furthermore, the radio base station 10 assigns the same period T3 to the plurality of radio communication terminals 30-1 and 30-4 for which the “capacity increasing mode” is determined. Furthermore, the radio base station 10 assigns a period T4 to the radio communication terminal 30-5 for which the “area expanding mode” is determined. In steps S107 to S110, the radio base station 10 communicates with the radio communication terminals 30-1 to 30-5 with the radio resources assigned in step S106. FIG. 8 only shows a downlink communication sequence.

In step S107, as shown in FIG. 2A, the radio base station 10 transmits a data signal to the radio communication terminal 30-2 of the “direct mode” with the radio resource (period T1 in FIG. 9) assigned in step S106 by using the non-directional beam directed to the entire cell C1. The radio base station 10 does not include the reflector ID of the reflector apparatus 20 in the data signal.

In step S108, as shown in FIG. 2B, the radio base station 10 transmits a data signal to the radio communication terminal 30-3 of the “reflector relay mode” with the radio resource (period T2 in FIG. 9) assigned in step S106 by using the directional beam B0 directed to the reflector apparatus 20. The radio base station 10 includes the reflector ID of the reflector apparatus 20 in the data signal.

In step S109, as shown in FIG. 2C, the radio base station 10 transmits a data signal to the radio communication terminals 30-1 and 30-4 of the “capacity increasing mode” by using the radio resource (period T3 in FIG. 9) assigned in step S106. To be more specific, the radio base station 10 transmits a data signal to the radio communication terminal 30-1 for the period T3 by using the non-directional beam directed to the entire cell C1 and transmits a data signal to the radio communication terminal 30-4 by using the directional beam B0 directed to the reflector apparatus 20. The radio base station 10 does not include the reflector ID of the reflector apparatus 20 in the data signal directed to the radio communication terminal 30-1, whereas the radio base station 10 includes the reflector ID in the data signal directed to the radio communication terminal 30-4.

In step S110 as shown in FIG. 2D, the radio base station 10 transmits a data signal to the radio communication terminal 30-5 of the “area expanding mode” with the radio resource (period T4 in FIG. 9) assigned in step S106 by using the non-directional beam directed to the entire cell C1 and the directional beam B0 directed to the reflector apparatus 20. The radio base station 10 does not include the reflector ID of the reflector apparatus 20 in one data signal but includes the reflector ID in the other data signal.

(Operations and Effects)

According to the radio communication system according to the first embodiment, the reflector apparatus 20 can report an optimum weight of the directional beam B0 corresponding to the highest effect of utilizing the reflector 201 to the radio base station 10. This makes it possible to sufficiently achieve the advantage of utilizing the reflector 201 arranged in the cell of the radio base station 10 and to improve the throughput of the entire radio communication system by carrying out communication using the reflector 201 according to the situation of the radio communication terminal 30.

The radio communication system according to the first embodiment uses a directional beam between the radio base station 10 and the reflector apparatus 20 in the reflector relay mode, and can thereby reduce interference with another reflector apparatus 20 or another radio communication terminal 30. As a result, it is possible to use a combined mode that combines the direct mode and reflector relay mode as a communication mode for the radio communication terminal 30 and effectively utilize radio resources.

Furthermore, the radio communication system according to the first embodiment does not transmit any directional beam to the reflector apparatus 20 when the radio communication terminal 30 is not located within the reflection area C2 of the reflector apparatus 20, and can thereby reduce interference with the radio communication terminal 30 in another cell or the radio communication terminal 30 in the direct mode.

Thus, the radio communication system according to the first embodiment effectively utilize radio resources in the radio communication system which expands coverage of the radio base station 10 by using the reflector apparatus 20, and can thereby improve the throughput in the entire radio communication system.

Hereinafter, second to fifth embodiments will describe in detail variations of cases where the radio base station 10 communicates with the radio communication terminal 30 via the reflector apparatus 20 in the aforementioned reflector relay mode. The following variations are also applicable to the radio communication terminal 30 that performs communication in a reflector relay mode in the combined mode (capacity increasing mode and area expanding mode) combining the reflector relay mode and direct mode.

### Second Embodiment

A case has been described in the first embodiment where the radio base station 10 communicates with one or a plurality of radio communication terminals 30 via one reflector apparatus 20 in a reflector relay mode. A second embodiment will describe a case where the radio base station 10 communicates with a plurality of radio communication terminals 30 in a reflector relay mode via different reflector apparatuses 20, focusing on differences from the first embodiment.

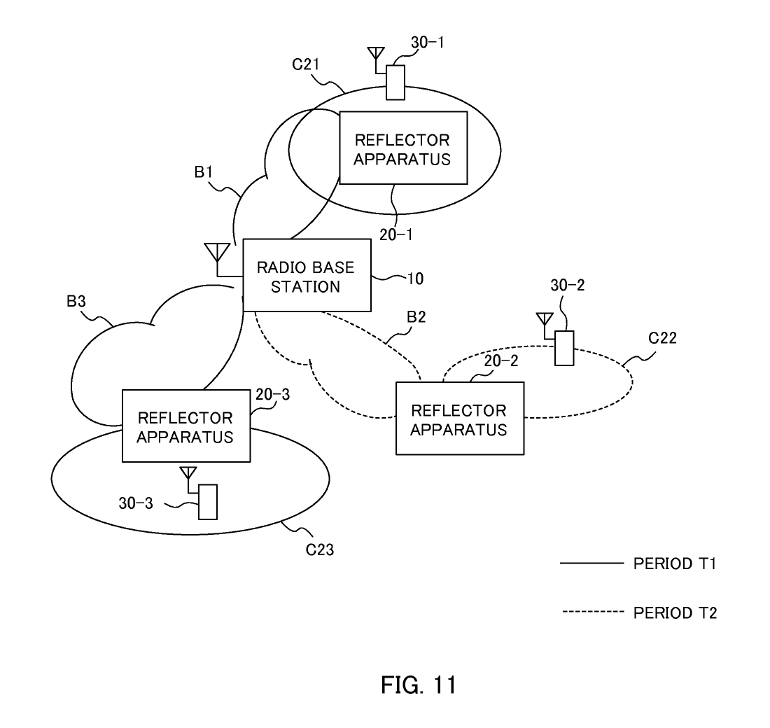

FIG. 11 is a schematic diagram of a radio communication system according to a second embodiment. As shown in FIG. 11, in the radio communication system according to the second embodiment, a plurality of reflector apparatuses 20-1 to 20-3 are arranged in a cell (not shown) of the radio base station 10 and radio communication terminals 30-1 to 30-3 are located in reflection areas C21 to C23 of the plurality of reflector apparatuses 20-1 to 20-3 respectively.

In the radio communication system shown in FIG. 11, the radio base station 10 communicates with the plurality of radio communication terminals 30-1 to 30-3 via the different reflector apparatuses 20-1 to 20-3 in a reflector relay mode. Directional beams B1 to B3 transmitted between the radio base station 10 and the reflector apparatuses 20-1 to 20-3 are used for such communication. In such a case, if the same radio resource (e.g., predetermined period or predetermined frequency) is assigned to the radio communication terminals 30-1 to 30-3, communication quality between the radio communication terminals 30-1 to 30-3 and radio base station 10 deteriorates due to interference between the directional beams B1 to B3.

Thus, the scheduling unit 110 of the radio base station 10 performs intra-area interference control whereby the same radio resource (e.g., predetermined period or predetermined frequency) is assigned to the selected radio communication terminals 30, which will be described later, so that communication qualities of the radio communication terminals 30-1 to 30-3 and the radio base station 10 satisfy their respective predetermined values.

For example, the scheduling unit 110 may randomly select predetermined number of radio communication terminals 30 from among the plurality of radio communication terminals 30 with which the radio base station 10 communicates via the different reflector apparatuses 20 and assigns the same radio resource to the plurality of selected radio communication terminals 30.

Furthermore, the scheduling unit 110 may sequentially select radio communication terminals 30 to which the same radio resource is assigned, from among the plurality of radio communication terminals 30 with which the radio base station 10 communicates via the different reflector apparatuses 20. To be more specific, the scheduling unit 110 selects one radio communication terminal 30 from among the plurality of radio communication terminals 30 and assigns a radio resource thereto. After that, the scheduling unit 110 selects another radio communication terminal 30 from among the plurality of radio communication terminals 30 and assigns the same radio resource thereto. When communication qualities of both the selected one radio communication terminal 30 and the other radio communication terminal 30 satisfy a predetermined value, the scheduling unit 110 assigns the same radio resource to both radio communication terminals 30. On the other hand, when their communication qualities do not satisfy the predetermined value, the scheduling unit 110 does not assign any radio resource to the other radio communication terminal 30. The scheduling unit 110 repeats the above operation.

In FIG. 11, the scheduling unit 110 assigns a period T1 to the radio communication terminals 30-1 and 30-3 selected as described above from the plurality of radio communication terminals 30-1 to 30-3, and further assigns a period T2 to the radio communication terminal 30-2.

Thus, the radio communication system according to the second embodiment selects radio communication terminals 30 to which the same radio resource is assigned, from among the plurality of radio communication terminals 30-1 to 30-3 with which the radio base station 10 communicates via the different reflector apparatuses 20, and can thereby prevent interference between the directional beams B1 to B3 used for the communication. Furthermore, as long as communication quality satisfies a predetermined value, the same radio resource can be used for the plurality of radio communication terminals 30 in the reflector relay mode, and it is thereby possible to improve the throughput of the entire radio communication system.

### Third Embodiment

A third embodiment will describe a radio communication system including a plurality of adjacent radio base stations 10 each forming a cell in which the reflector apparatus 20 is arranged, focusing on differences from the aforementioned embodiment.

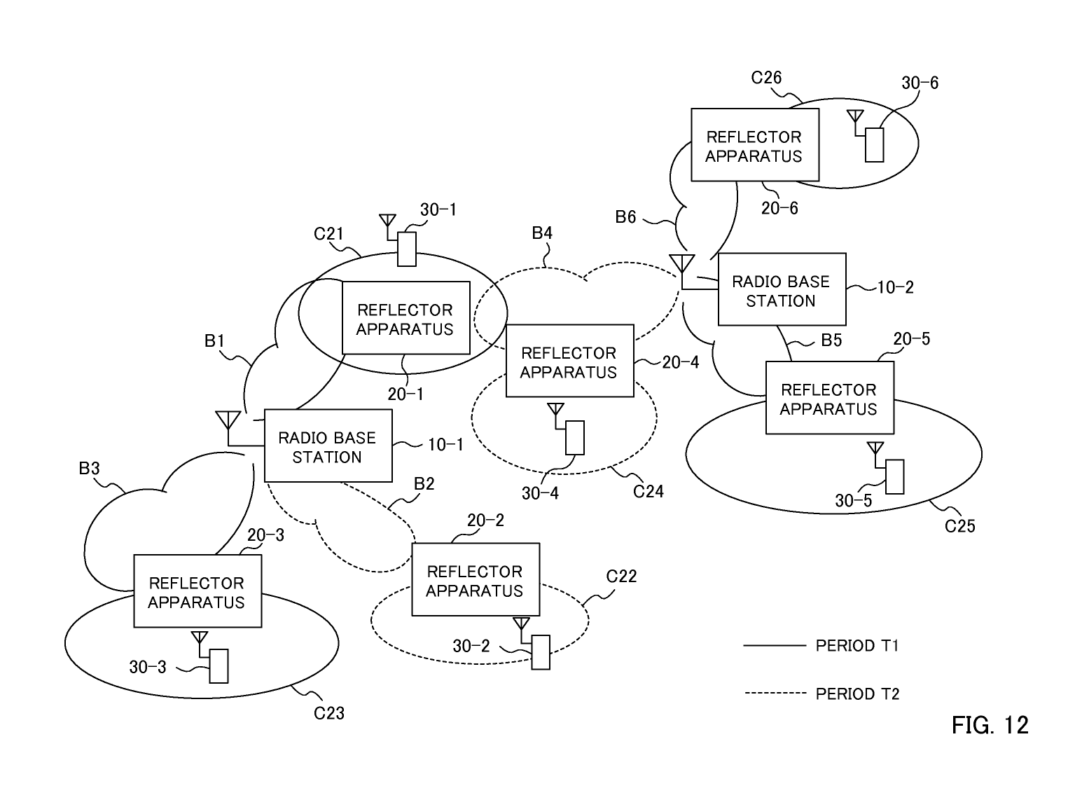

FIG. 12 is a schematic diagram of a radio communication system according to a third embodiment of the present invention. As shown in FIG. 12, in the radio communication system according to the third embodiment, a plurality of reflector apparatuses 20-1 to 20-3 are arranged in a cell (not shown) of a radio base station 10-1 and radio communication terminals 30-1 to 30-3 are located within reflection areas C21 to C23 of the plurality of reflector apparatuses 20-1 to 20-3 respectively. Likewise, a plurality of reflector apparatuses 20-4 to 20-6 are arranged in a cell (not shown) of a radio base station 10-2 adjacent to the radio base station 10-1 and radio communication terminals 30-4 to 30-6 are located in reflection areas C24 to C26 of the plurality of reflector apparatuses 20-4 to 20-6 respectively.

In the radio communication system shown in FIG. 12, the radio base station 10-1 communicates with the radio communication terminals 30-1 to 30-3 via the different reflector apparatuses 20-1 to 20-3 in a reflector relay mode. Directional beams B1 to B3 transmitted between the radio base station 10 and the reflector apparatuses 20-1 to 20-3 are used respectively for such communication. Likewise, the radio base station 10-2 communicates with radio communication terminals 30-4 to 30-6 via different reflector apparatuses 20-4 to 20-6 in a reflector relay mode. Directional beams B4 to B6 transmitted between the radio base station 10 and the reflector apparatuses 20-4 to 20-6 are used respectively for such communication.

In the case shown in FIG. 12, inter-cell interference occurs in an adjacent area of the cells (not shown) of the radio base stations 10-1 and 10-2. To reduce the inter-cell interference, the scheduling units 110 of the adjacent radio base stations 10-1 and 10-2 coordinate the communication modes of radio communication terminals 30 to which the same radio resources are assigned in the adjacent radio base stations 10-1 and 10-2.

Here, control is performed beforehand in the radio communication system according to the third embodiment such that the allocation ratio and allocated radio resources of the radio resource a for direct mode, radio resource b for combined mode including a capacity increasing mode and area expanding mode and radio resource c for reflector relay mode shown in FIG. 5A are equal between the adjacent radio base stations 10-1 and 10-2.

Therefore, the scheduling units 110 of the adjacent radio base stations 10-1 and 10-2 assign the radio communication terminals 30 in the same communication mode to the same radio resource. That is, radio resources assigned to the radio communication terminal 30 of the “reflector relay mode” by the scheduling unit 110 of the radio base station 10-1 are also assigned to the radio communication terminal 30 of the “reflector relay mode” by the scheduling unit 110 of the radio base station 10-2 and never assigned to the radio communication terminals 30 of other communication modes.

Thus, between the adjacent radio base stations 10-1 and 10-2, the communication modes of the radio communication terminals 30 to which the same radio resources are assigned are coordinated, and it is thereby possible to reduce inter-cell interference between the adjacent radio base stations 10-1 and 10-2.

Furthermore, in order to further reduce inter-cell interference, the scheduling units 110 of the adjacent radio base stations 10-1 and 10-2 may also assign different radio resources to the plurality of radio communication terminals 30 located in an adjacent area of the cells (not shown) of the radio base stations 10-1 and 10-2. With reference to FIG. 12, such radio resource allocation will be described in detail.

In the case as shown in FIG. 12, when the same radio resource is assigned to the radio communication terminals 30-1 and 30-4 located in the adjacent area of the cells of the radio base stations 10-1 and 10-2, interference between signals transmitted/received between the radio base station 10-1, reflector apparatus 20-1 and radio communication terminal 30-1, and signals transmitted/received between the radio base station 10-2, reflector apparatus 20-4 and radio communication terminal 30-4 causes communication quality of both signals to deteriorate.

Therefore, the scheduling units 110 of the radio base stations 10-1 and 10-2 assign different radio resources to the plurality of radio communication terminals 30-1 and 30-4 located in the neighboring areas. For example, in FIG. 12, the scheduling unit 110 of the radio base station 10-1 assigns the period T1 to the radio communication terminal 30-1. On the other hand, the scheduling unit 110 of the radio base station 10-2 assigns the period T2 to the radio communication terminal 30-4.

Furthermore, the scheduling units 110 of the radio base stations 10-1 and 10-2 may further perform the intra-cell interference control described in the second embodiment. For example, in FIG. 12, to prevent intra-cell interference with the directional beam B1 transmitted for the period T1, the scheduling unit 110 of the radio base station 10-1 assigns the period T2 to the radio communication terminal 30-2 with which the radio base station 10-1 communicates by using the directional beam B2. On the other hand, the scheduling unit 110 of the radio base station 10-1 assigns the same period T1 as that of the radio communication terminal 30-1 to the radio communication terminal 30-3 with which the radio base station 10-1 communicates by using a directional beam B3 which has less influence on the directional beam B1. Likewise, to prevent intra-cell interference with a directional beam B4 transmitted for the period T2, the scheduling unit 110 of the radio base station 10-2 assigns the period T1 to radio communication terminals 30-5 and 30-6 with which the radio base station 10-2 communicates by using directional beams B5 and B6.

Thus, according to the radio communication system according to Embodiment 3, the communication modes of radio communication terminals 30 to which the same resources are assigned are coordinated in between the adjacent base stations 10-1 and 10-2, while respective different radio resources are assigned to a plurality of radio communication terminals 30 located in the adjacent area of the cells of a plurality of radio base stations 10, and it is thereby possible to prevent inter-cell interference in the adjacent radio base stations 10. Further, as long as inter-cell interference satisfies a predetermined value, it is possible to share the same radio resources among a plurality of adjacent radio base stations 10, and throughput can thereby be improved.

### Fourth Embodiment

A fourth embodiment will describe a case where the radio base station 10 communicates with one radio communication terminal 30 in a reflector relay mode via different reflector apparatuses 20, focusing on differences.

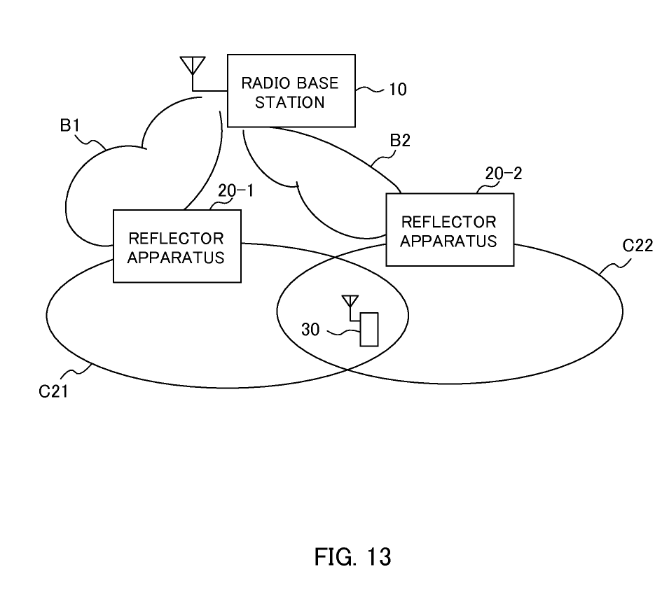

FIG. 13 is a schematic diagram of a radio communication system according to a fourth embodiment of the present invention. In the radio communication system according to the fourth embodiment, as shown in FIG. 13, a plurality of reflector apparatuses 20-1 and 20-2 are arranged in the cell of the radio base station 10. The reflector apparatuses 20-1 and 20-2 form reflection areas C21 and C22, and the radio communication terminal 30 is located in an adjacent area of the reflection areas C21 and C22.

In the radio communication system shown in FIG. 13, the radio base station 10 communicates with the radio communication terminal 30 in the reflector relay mode via the different reflector apparatuses 20-1 and 20-2. Directional beams B1 and B2 transmitted between the radio base station 10 and reflector apparatuses 20-1 and 20-2 are used for such communication.

In the case shown in FIG. 13, the radio base station 10 communicates with the radio communication terminal 30 via the reflector apparatuses 20-1 and 20-2 in a reflector relay mode based on a report from the radio communication terminal 30 (that is, report indicating that the radio communication terminal 30 can perform communication via the reflector apparatuses 20-1 and 20-2). Furthermore, the radio communication terminal 30 receives a second control signal including a reflector ID of the reflector apparatus 20-1 from the reflector apparatus 20-1 and receives a second control signal including a reflector ID of the reflector apparatus 20-2 from the reflector apparatus 20-2. The radio communication terminal 30 determines whether or not communication is possible via the reflector apparatuses 20-1 and 20-2 based on receiving power of the two second control signals received from the reflector apparatuses 20-1 and 20-2.

Thus, in the radio communication system according to the fourth embodiment, the radio base station 10 can communicate with one radio communication terminal 30 in a reflector relay mode via the different reflector apparatuses 20, and can thereby further expand coverage of the radio base station 10

### Fifth Embodiment

A fifth embodiment will describe a case where a plurality of radio base stations 10 communicate with one radio communication terminal 30 in a reflector relay mode via one reflector apparatus 20, focusing on differences.

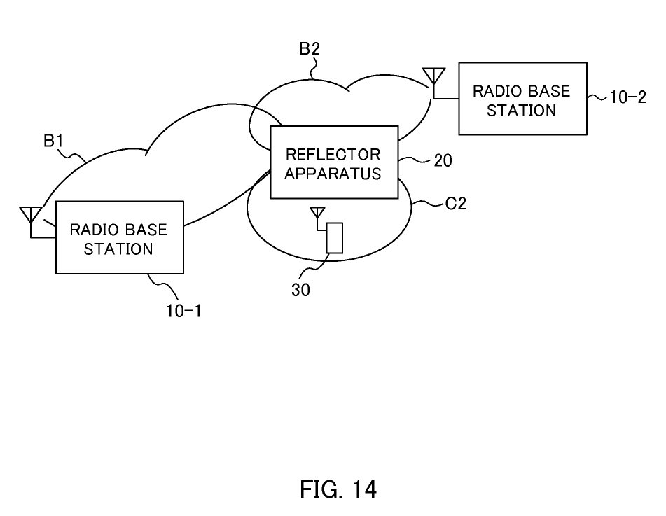

FIG. 14 is a schematic diagram of a radio communication system according to a fifth embodiment of the present invention. In the radio communication system according to the fifth embodiment, as shown in FIG. 14, a reflector apparatus 20 is arranged in an adjacent area of cells (not shown) of a radio base station 10-1 and a radio base station 10-2, and a radio communication terminal 30 is located in a reflection area C2 of the reflector apparatus 20.

In the radio communication system shown in FIG. 14, the radio base stations 10-1 and 10-2 communicate with the radio communication terminal 30 in the reflector relay mode via one reflector apparatus 20. Directional beams B1 and B2 transmitted between the radio base stations 10-1 and 10-2, and the reflector apparatus 20 are used for such communication.

In the case shown in FIG. 14, the reflector apparatus 20 reports to the surrounding radio base stations 10-1 and 10-2 that communication is possible via the reflector apparatus 20 (registration request). In response to the registration request from the reflector apparatus 20, the radio base stations 10-1 and 10-2 communicate with the radio communication terminal 30 via the reflector apparatus 20.

Thus, in the radio communication system according to the fifth embodiment, the plurality of adjacent radio base stations 10 communicate with one radio communication terminal 30 of a reflector relay mode via one reflector apparatus 20, and can thereby further expand coverage of the radio base stations 10.

### Other Embodiments

In the aforementioned embodiments, a reflector apparatus 20 provided with a reflector capable of dynamically controlling reflection characteristics is applied. A more specific example of the reflector capable of dynamically controlling reflection characteristics is as follows.

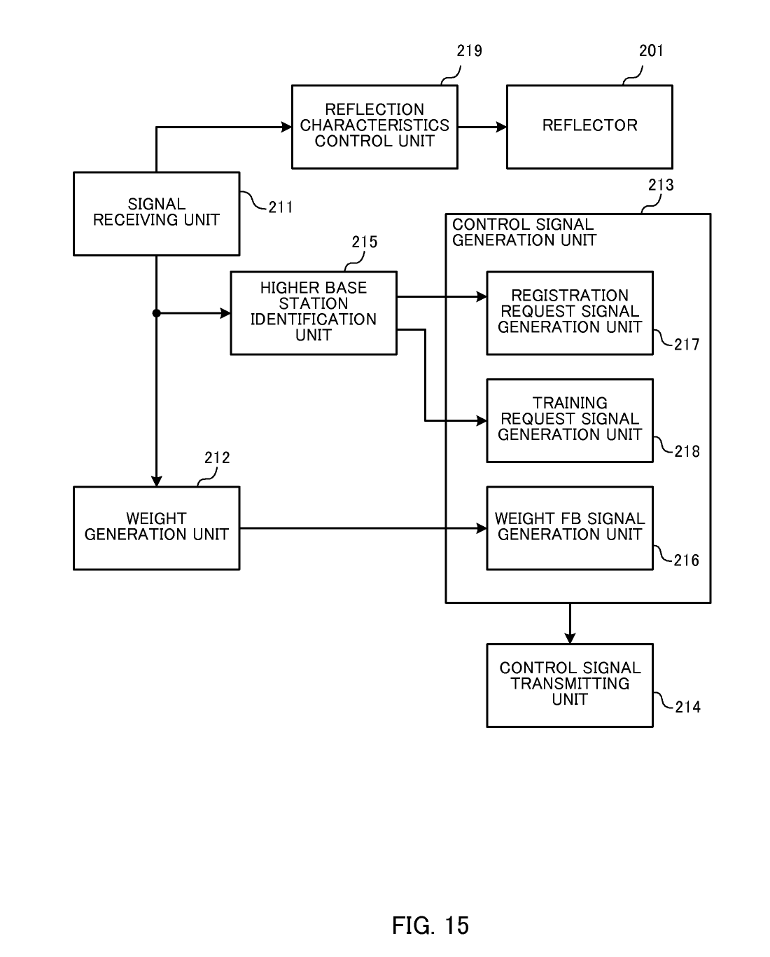

FIG. 15 is a function block of a control unit of the reflector apparatus 20 capable of dynamically controlling reflection characteristics. Such a control unit of the reflector apparatus 20 includes a reflection characteristics control unit 219 (control unit) in addition to the configuration shown in FIG. 7. Furthermore, a passive element array arranged in a planar shape is used as the reflector 201 shown in FIG. 6 and the passive element array is connected to a variable reactor. Passive element arrays are described in K. Gyoda, T. Ohira, “Design of electronically steerable passive array radiator (ESPAR) antennas”, IEEE Antennas and Propagation Society International Symposium, 2000, vol. 2, pp. 922-925 or the like.

A reflection characteristics control unit 219 controls reflection characteristics of a signal entering from the radio base station 10 by controlling the reflector 201 according to a reflector ID included in a second control signal from the radio base station 10. To be more specific, the reflection characteristics control unit 219 controls the variable reactor connected to a passive element array used as the reflector 201 and thereby controls the reflection direction of the signal entering the passive element array.

The radio base station 10 transmits a control signal including a reflector ID (identification information) which differs according to reflection characteristics to the reflector apparatus 20 having the aforementioned control unit. The reflection characteristics control unit 219 of the reflector apparatus 20 identifies the reflector ID of the control signal received from the signal receiving unit 211 and identifies the reflection characteristics from the identified reflector ID. The reflection characteristics control unit 219 controls the aforementioned reflector 201 so as to achieve the reflection characteristics designated by the radio base station 10.

Furthermore, as another method, information on current reflection characteristics is broadcast from the reflector apparatus 20 to the radio communication terminal 30. The information is transmitted to the radio communication terminal 30 by using a control signal transmitting unit 214. The radio communication terminal 30 transmits a control signal indicating the kind of reflection characteristics to be applied to the reflector 201 to the reflector apparatus 20. The reflection characteristic control unit 219 of the reflector apparatus 20 controls the aforementioned reflector 201 so as to achieve the reflection characteristics corresponding to the control signal received from the radio communication terminal 30 through the signal receiving unit 211.

Furthermore, the reflector apparatus 20 recognizes the time during which a directional beam is directed to the reflector 201 by a control signal from the radio base station 10 and recognizes a signal transmitted from the radio communication terminal 30 to the radio base station 10 via the reflector. The reflector apparatus 20 then applies reflection characteristics required according to a transmission situation (“heavy traffic reflection characteristic” or “reflection characteristic suitable for a transmitting terminal”).

Furthermore, when receiving an uplink signal from the radio communication terminal 30 via the reflector apparatus 20, the radio base station 10 may appropriately control a reception weight of the antenna 101. To be more specific, when receiving an uplink signal from the radio communication terminal 30 via the reflector apparatus 20, the radio base station 10 determines reflection characteristics to reflect an uplink signal from the radio communication terminal 30 and reports the reflection characteristics to the reflector apparatus 20. The radio base station 10 determines the reception weight of the antenna 101 to receive the uplink signal reflected by the reflector apparatus 20 based on the determined reflection characteristics.

As a method of forming an optimum weight of a directional beam, the aforementioned embodiments have described the method (feedback utilizing method) whereby the reflector apparatus 20 generates an optimum weight based on a training signal from the radio base station 10 and reports the optimum weight generated to the radio base station 10. However, the radio base station 10 may also use an identical frequency channel sounding method which generates an optimum weight based on a channel sounding signal from the reflector apparatus 20.

What is claimed is:

1. A reflector apparatus arranged in a cell formed by a radio base station, comprising:
a reflector configured to reflect a directional beam transmitted from an array antenna of the radio base station to the reflector apparatus;
a receiving unit configured to receive a training signal transmitted from the radio base station;
a weight generating unit configured to generate an optimum weight of the directional beam transmitted from the radio base station, based on a reception result of the training signal by the receiving unit; and
a transmitting unit configured to transmit weight information indicating the optimum weight generated by the weight generating unit to the radio base station.

2. The reflector apparatus according to claim 1, wherein the reflector is configured to control reflection characteristics,
the directional beam transmitted from the radio base station includes identification information which differs according to the reflection characteristics, and
the reflector apparatus comprises a control unit configured to control the reflector so as to reflect the directional beam according to reflection characteristics corresponding to the identification information included in the directional beam.

3. A radio base station forming a cell in which at least one reflector apparatus according to claim 1 is arranged, comprising:
an acquiring unit configured to acquire, from each radio communication terminal, receiving power information of a first control signal transmitted from the radio base station and received by each radio communication terminal and receiving power information of a second control signal transmitted from the radio base station by using a directional beam directed to the reflector apparatus and received by each radio communication terminal;
a communication mode determining unit configured to determine a communication mode for each radio communication terminal from among a direct mode for communicating without the reflector apparatus, a reflector relay mode for communicating via the reflector apparatus by using a directional beam formed between the radio base station and the reflector apparatus, and a combined mode for communicating by combining the direct mode and the reflector relay mode, based on the receiving power information acquired from the each radio communication terminal; and
a communication unit configured to communicate with the each radio communication terminal by using the communication mode determined for the each radio communication terminal.

4. The radio base station according to claim 3, wherein the combined mode includes a capacity increasing mode for communicating with a radio communication terminal by the direct mode in addition to communicating with another radio communication terminal by the relay mode, by using a same radio resource.

5. The radio base station according to claim 4, wherein the combined mode includes an area expanding mode for communicating with a radio communication terminal by both the direct mode and the relay mode by using a same radio resource.

6. The radio base station according to claim 3, further comprising an allocation unit configured to assign a radio resource to the each radio communication terminal according to the communication mode determined for the each radio communication terminal.

7. The radio base station according to claim 6, wherein when the communication unit is configured to communicate with a plurality of radio communication terminals via different reflector apparatuses by the reflector relay mode, the allocation unit is configured to assign a same radio resource to at least one radio communication terminal selected from the plurality of radio communication terminals so that communication quality of each of the plurality of radio communication terminals satisfies a predetermined value.

8. The radio base station according to claim 6, wherein the allocation unit is configured to coordinate communication modes for radio communication terminals to which the same radio resource is assigned, between the radio base station and an adjacent radio base station.

9. The radio base station according to claim 3, wherein the communication unit is configured to communicate with a radio communication terminal for communicating by the reflector relay mode, via a plurality of reflector apparatuses.

10. A radio communication method for a radio communication system including a radio base station and at least one reflector apparatus according to claim 1 arranged in a cell formed by the radio base station, comprising:
acquiring, in the radio base station, from each radio communication terminal, receiving power information of a first control signal transmitted from the radio base station and received by each radio communication terminal and receiving power information of a second control signal transmitted from the radio base station by using a directional beam directed to the reflector apparatus and received by each radio communication terminal;
determining, in the radio base station, a communication mode for each radio communication terminal from among a direct mode for communicating without the reflector apparatus, a reflector relay mode for communicating via the reflector apparatus by using a directional beam formed between the radio base station and the reflector apparatus, and a combined mode for communicating by combining the direct mode and the reflector relay mode, based on the receiving power information acquired from the each radio communication terminal; and
communicating, in the radio base station, with the each radio communication terminal by using the communication mode determined for the each radio communication terminal.
